(19) United States
(12) Patent Application Publication
(10) Pub. No.: US 2007/0279370 A1
(43) Pub. Date: Dec. 6, 2007

(54) Field-sequential liquid crystal display and method for driving the same

(75) Inventors: Chia-Yu Lee, Taipei (TW); Ting-Jui Chang, Taipei City (TW); Kun-Yu Lin, Hsin-Chu City (TW); Po-Lun Chen, Chia-I City (TW); Jeng-Fang Wu, Tzu-Kuan Hsiang (TW)

Correspondence Address: BIRCH STEWART KOLASCH & BIRCH, PO BOX 747, FALLS CHURCH, VA, 22040-0747, US

(73) Assignee: AU Optronics Corporation

(21) Appl. No.: 11/509,659

(22) Filed: Aug. 25, 2006

(30) Foreign Application Priority Data
Jun. 2, 2006 (TW) 95119545

(51) Int. Cl. G09G 3/36

(52) U.S. Cl. 345/102

(57) ABSTRACT

A field-sequential liquid crystal display and method for driving the same are disclosed to provide sufficient gate-on time for attaining a high-resolution field-sequential liquid crystal display. According to one embodiment of the present invention, at least two adjacent rows of pixels are scanned to turn on transistors during a scan period. During the same scan period, image data are respectively provided to the at least two adjacent rows of pixels to charge associated capacitors for display.

### CROSS-REFERENCE TO RELATED APPLICATION

This application claims the benefit of Taiwan Patent Application Serial No. 95119545, filed Jun. 2, 2006, the subject matter of which is incorporated herein by reference.

### BACKGROUND OF THE INVENTION

1. Field of the Invention

The present invention generally relates to a field-sequential liquid crystal display and a method for driving the same, and more particularly to the field-sequential liquid crystal display using a scan line for controlling at least two adjacent rows of pixels.

2. Description of the Prior Art

The field-sequential color liquid crystal display (FSC LCD) has advantages over the conventional thin film transistor liquid crystal display (TFT LCD). The color filter is not required in the FSC LCD as the FSC LCD itself has a red/green/blue backlight source. Accordingly, compared to the TFT LCD, the FSC LCD has higher luminance because of improved transmission, and has higher contrast owing to the elimination of polarization absorption and deflection by the color filter.

FIG. 1 shows an exploded view of a conventional FSC LCD, which includes an LCD panel 10, a backlight device (such as a backlight module) 20, a scan driver (or gate driver) 30, and a data driver (or source driver) 40. Specifically, the LCD panel 10 has a common electrode 12, a common substrate 14 for holding the common electrode 12, a liquid crystal layer 16, and an array substrate 18. The backlight device 20 has some polarizer sheets 22 and a backlight source 24 which provides red, green, and blue light.

FIG. 2 shows a configuration of driving a conventional FSC LCD. The scan driver 30 couples to scan lines arranged horizontally, each scan line being coupled to the gates of transistors in a whole row of pixels. The data driver 40 couples to data lines arranged vertically, each data line being coupled to the sources of the transistors in a whole column of the pixels. In operation, the scan driver 30 provides trigger signals to the scan lines in order (for example, from top to bottom as indicated by the arrow in the figure) to turn-on the transistors for receiving image data provided by the data driver 40 and then charging the associated capacitors of the turn-on pixels.

Regarding a conventional TFT LCD driven at a scan rate of 60 hertz (Hz), the display time of a frame is 16.6 (=1/60) milliseconds (ms). For the TFT LCD having pixels arranged in 1280 columns by 800 rows (for example, the WXGA protocol), the turn-on time (also called gate-on time) of a row of pixels is thus 20.75 (=16.6 m/800) microseconds (μs), during which time the data driver provides image data to the turn-on row of pixels and then effectively charges the associated capacitors of the turn-on pixels.

FIG. 3 shows the timing diagram of a conventional FSC LCD. For example, the FSC LCD has pixels arranged in 1280 columns by 800 rows (for example, the WXGA protocol), which is divided into four blocks with each block having pixels in 1280 columns by 200 rows and each block being illuminated by an individual backlight source. Regarding the FSC LCD driven at a scan rate of 180 Hz, the display time of a frame is 5.6 (=1/180) ms. Within this display time, 1.6 ms is used to drive one block (i.e., 200 rows of pixels), while 2 ms is for response time of the liquid crystal and the other 2 ms is for turning on the backlight source. Accordingly, the gate-on time of a row of pixels is only 8 (=1.6 m/200) μs.

For the reason discussed above, a need has arisen to propose an improved configuration of driving an FSC LCD that could provide sufficient gate-on time for attaining a high-resolution FSC LCD without increasing chip area.

### SUMMARY OF THE INVENTION

In view of the foregoing, it is an object of the present invention to provide an FSC LCD and a method for driving the FSC LCD that could provide sufficient gate-on time for attaining a high-resolution FSC LCD.

Another object of the present invention is to propose configuration for reducing quantity of scan lines, thereby lessening the burden of the scan driver.

According to the object, the present invention provides a field-sequential liquid crystal display, which includes a liquid crystal panel, a backlight source, a scan driver, and a data driver. The liquid crystal panel includes a number of pixels arranged in an array; a number of scan lines, each being electrically connected to at least two adjacent rows of the pixels; and groups of data lines, each group being adapted to provide image data to a corresponding column of pixels, and each group including a number of data lines that are coupled to adjacent pixels corresponding to the at least two adjacent rows of the pixels. The backlight source provides light. The scan driver controls display of the pixels via the scan lines; and the data driver provides the image data to the pixels via the groups of data lines.

### BRIEF DESCRIPTION OF THE DRAWINGS

FIG. 1 shows an exploded view of a conventional FSC LCD;

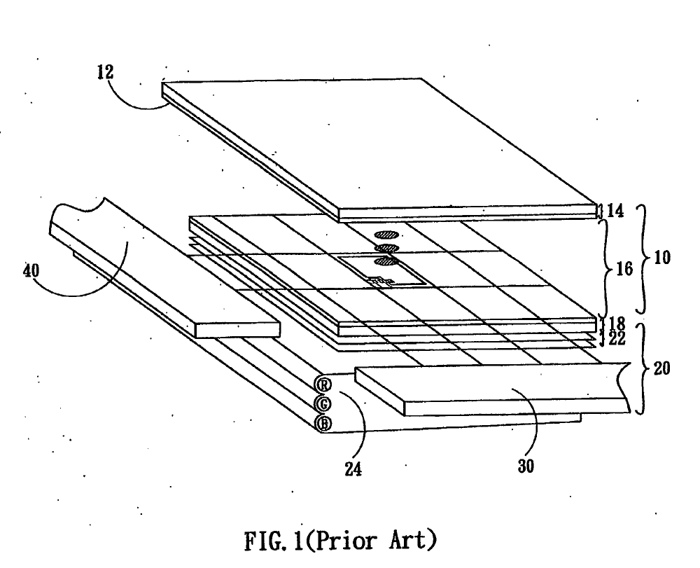

FIG. 2 shows a configuration of driving a conventional FSC LCD;

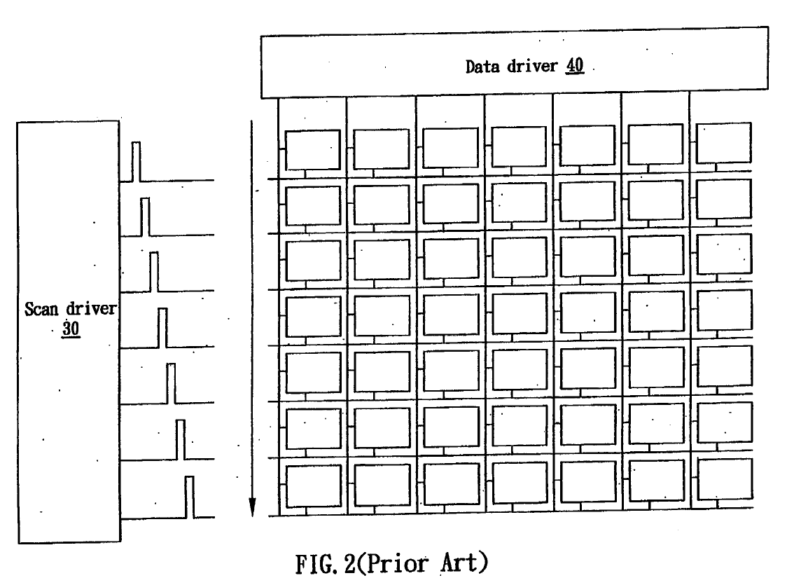

FIG. 3 shows the timing diagram of a conventional FSC LCD;

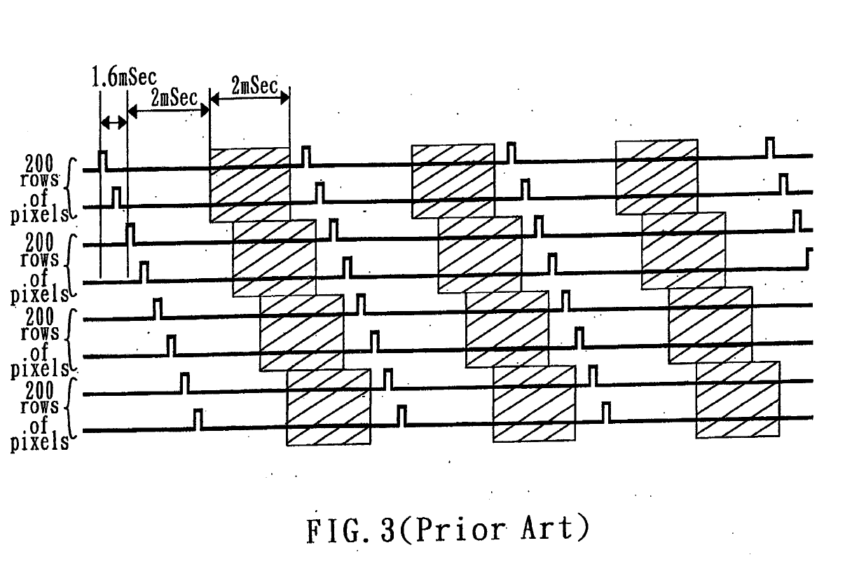

FIG. 4 shows a configuration of driving an FSC LCD according to one embodiment of the present invention; and

FIG. 5 shows a flow diagram illustrating a method for driving an FSC LCD according to the embodiment of the present invention.

### DETAILED DESCRIPTION OF THE INVENTION

The detailed description of the present invention will be discussed in the following embodiments, which are not intended to limit the scope of the present invention, but can be adapted for other applications.

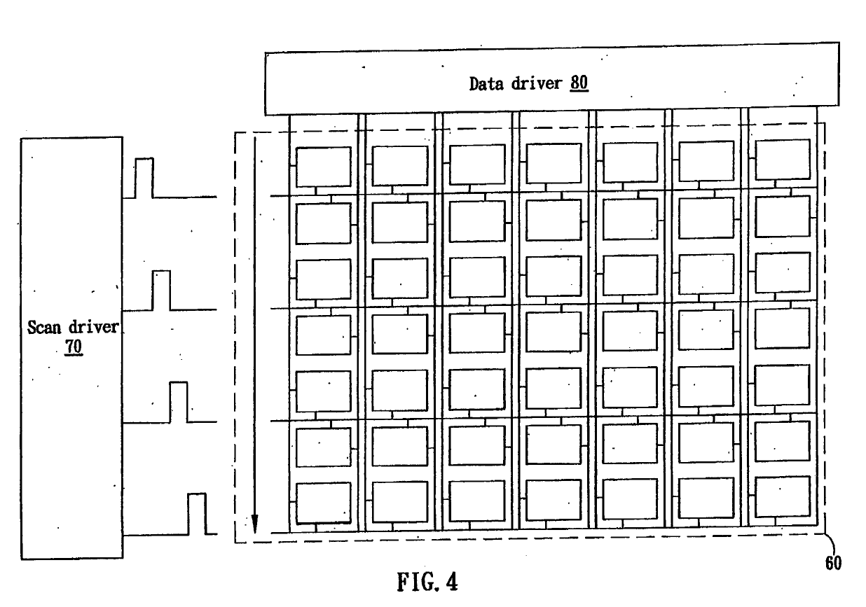

FIG. 4 shows a configuration of driving a field-sequential color liquid crystal display (FSC LCD) according to one embodiment of the present invention. In the embodiment, the FSC LCD primarily includes an LCD panel 60, a scan driver (or gate driver) 70, and a data driver (or source driver) 80. Specifically, the LCD panel 60 includes pixels arranged in array, and a number of scan lines, each scan line being electrically connected to at least two rows of pixels. In the embodiment, each scan line is electrically connected to two adjacent rows of pixels. Further, the LCD panel 60 also includes several pairs (or groups) of data lines, each pair being adapted to provide image data to a corresponding column of pixels, while the data lines of each pair being respectively and alternatively coupled to adjacent pixels (i.e., odd and even pixels in this embodiment) as shown in the figure.

The scan driver 70 provides trigger signals to the scan lines in order (for example, from top to bottom as indicated by the arrow in the figure). It is appreciated, however, that other order could be used such as from bottom to top. In the embodiment, each scan line controls two adjacent rows of pixels, and therefore each trigger signal is provided to the gates of transistors (such as thin film transistors) in two adjacent rows of pixels and turns on the transistors. At this moment, the sources of the turn-on transistors receive image data provided by the data driver 80 via the pairs of data lines, and then the associated capacitors of the turn-on transistors are charged for display.

Compared to the conventional FSC LCD, each scan line controls two adjacent rows of pixels at the same time in the FSC LCD according to the present embodiment, and thus the gate-on time of each row of pixels could be sustained two times or longer than that in the conventional FSC LCD. For example, an FSC LCD has pixels arranged in 1280 columns by 800 rows (for example, the WXGA protocol), which is divided into four blocks with each block having pixels in 1280 columns by 200 rows and each block being illuminated by an individual backlight source. Regarding the FSC LCD driven at a scan rate of 180 Hz, the display time of a frame is 5.6 (=1/180) ms. Within this display time, 1.6 ms is used to drive one block (i.e., 200 rows of pixels), while 2 ms is for response time of the liquid crystal and the other 2 ms is for turning on the backlight source. Accordingly, the gate-on time of two rows of pixels controlled by one scan line is 16 (=1.6 m/(200/2)) μs. Although each scan line is used to control two rows of pixels in this embodiment, it is appreciated that those skilled in the art could instead utilize each scan line to control three or more rows of pixels.

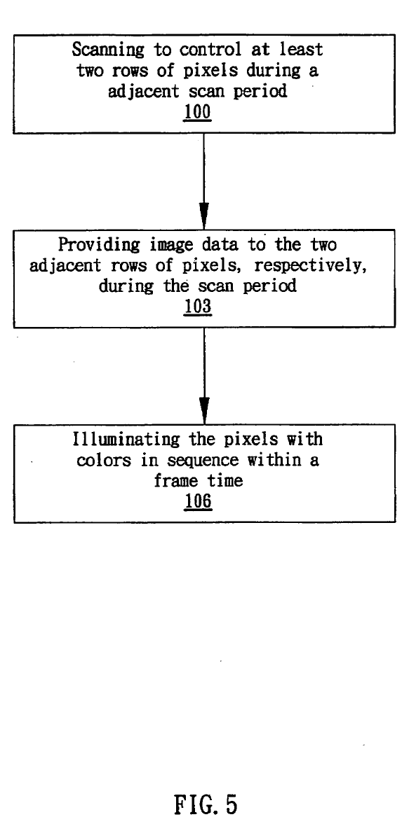

To sum up the method for driving the FSC LCD according to the present invention, a flow diagram is illustrated in FIG. 5. First of all, at least two adjacent rows of pixels are scanned and controlled during a scan period (step 100), so that the gates of thin film transistors in these rows of pixels receive a trigger signal to turn on the thin film transistors. Within the same scan period, these rows of pixels respectively receive image data so that the associated capacitors of the turn-on transistors are charged for display (step 103). Finally, the backlight device illuminates the pixels with colors in sequence within a frame time (step 106).

Although specific embodiments have been illustrated and described, it will be appreciated by those skilled in the art that various modifications may be made without departing from the scope of the present invention, which is intended to be limited solely by the appended claims.

What is claimed is:

1. A field-sequential liquid crystal display, comprising:
a liquid crystal panel, comprising:
a plurality of pixels arranged in an array;
a plurality of scan lines, each being electrically connected to at least two adjacent rows of the pixels; and
a plurality groups of data lines, each group being adapted to provide image data to a corresponding column of pixels and including a plurality of data lines coupled to adjacent pixels corresponding to the at least two adjacent rows of the pixels;
a backlight source for providing light;
a scan driver for controlling display of the pixels via the scan lines; and
a data driver for providing the image data to the pixels via the groups of data lines.

2. The field-sequential liquid crystal display according to claim 1, wherein each pixel includes a thin film transistor.

3. The field-sequential liquid crystal display according to claim 2, wherein the plurality of scan lines are coupled to the gates of the plurality of thin film transistors.

4. The field-sequential liquid crystal display according to claim 2, wherein the plurality of data lines are coupled to the sources of the plurality of thin film transistors.

5. The field-sequential liquid crystal display according to claim 1, wherein the backlight source is adapted to provide red, green, and blue light.

6. A field-sequential liquid crystal display, comprising:
a liquid crystal panel, comprising:
a plurality of pixels arranged in an array with 2×m rows and n columns, where m and n are positive integers;
m scan lines for controlling two adjacent rows of the pixels; and
n groups of data lines for providing image data to a corresponding column of pixels, each group including two data lines coupled to odd and even rows of pixels, respectively;
a backlight source for providing red, green, and blue light;
a scan driver for controlling display of the pixels via the m scan lines; and
a data driver for providing the image data to the pixels via the n groups of data lines.

7. The field-sequential liquid crystal display according to claim 6, wherein each pixel includes a thin film transistor.

8. The field-sequential liquid crystal display according to claim 7, wherein the plurality of scan lines are coupled to the gates of the plurality of thin film transistors.

9. The field-sequential liquid crystal display according to claim 7, wherein the data lines are coupled to the sources of the plurality of thin film transistors.

10. A method for driving a field-sequential liquid crystal display including a plurality of pixels arranged in an array, the method comprising:
scanning at least two adjacent rows of pixels during a scan period;
providing image data to at least two adjacent rows of pixels, respectively, during the scan period; and
illuminating the pixels with colors in sequence within a frame time.

11. The method according to claim 10, wherein the at least two adjacent rows of pixels are controlled by one scan line.

12. The method according to claim 10, wherein the image data are provided to the at least two adjacent rows of pixels, respectively, during the scan period via a plurality groups of data lines.

13. The method according to claim 10, wherein the field-sequential liquid crystal display includes m scan lines, where m is a positive integer, each scan line being configured to control two adjacent rows of the pixels.

14. The method according to claim 13, wherein the field-sequential liquid crystal display includes n groups of data lines, where n is a positive integer, each group being adapted to provide the image data to a corresponding column of pixels, and each group including two data lines that are coupled to odd and even rows of pixels, respectively.

15. The method according to claim 10, wherein illuminating the pixels comprises:
providing red light to the pixels;
providing green light to the pixels; and
providing blue light to the pixels.
